(19) United States
(12) Patent Application Publication
(10) Pub. No.: US 2025/0322991 A1
(43) Pub. Date: Oct. 16, 2025

(54) EMBEDDED MULTI-LAYER CERAMIC CAPACITOR

(71) Applicant: YAGEO CORPORATION, Kaohsiung City (TW)

(72) Inventors: Ming-Chun WU, Kaohsiung City (TW); Hsin-Yen LIU, Kaohsiung City (TW); Fen-Sheng HSU, Kaohsiung City (TW); Te-Hua CHUNG, Kaohsiung City (TW); Huang Kai SU, Kaohsiung City (TW)

(21) Appl. No.: 18/731,374

(22) Filed: Jun. 3, 2024

(30) Foreign Application Priority Data
Apr. 10, 2024 (TW) 113113421

(51) Int. Cl. H01G 4/012; H01G 4/232; H01G 4/30

(52) U.S. Cl. CPC H01G 4/012; H01G 4/2325; H01G 4/30

(57) ABSTRACT

An embedded multi-layer ceramic capacitor includes a multi-layer brick, and first and second terminal electrodes. The multi-layer brick includes a ceramic body, and plural first and second internal electrodes. The ceramic body has upper and lower surfaces, and first and second side surfaces opposite to each other. The first and second internal electrodes are embedded in the ceramic body alternately. Each first and second internal electrode includes first and second portions. The first portion extends between the first and second side surfaces, and is spaced apart from the first and second side surfaces, and the upper and lower surfaces. The second portion extends from a portion of a top surface of the first portion to the upper surface. The second portions of the first and second internal electrodes are opposite to each other. The first and second terminal electrodes cover the top surfaces of the second portions.

### RELATED APPLICATIONS

This application claims priority to Taiwan Application Serial Number 113113421, filed Apr. 10, 2024, which is herein incorporated by reference.

### BACKGROUND

### Field of Invention

The present disclosure relates to a technology for manufacturing a capacitor, and more particularly, to an embedded multi-layer ceramic capacitor (MLCC).

### Description of Related Art

Multi-layer ceramic capacitors are a kind of ceramic capacitors, and capacitance of which is mainly proportional to a surface area of the product and a number of stacked ceramic films. The multi-layer ceramic capacitors can be directly mounted by a surface mount technology (SMT), and the multi-layer ceramic capacitors are easy to be formed into chips and have small volumes, such that the multi-layer ceramic capacitors have become a mainstream product in the capacitor industry and are applied in various electronic devices.

An embedded packaging technology integrates passive devices, such as capacitors and resistors, into a multi-layer structure of a circuit board or a package carrier, to reduce the areas where the passive devices disposed on a surface of the circuit board or the package carrier, and leave the space of the surface of the circuit board or the package carrier for integrated circuits. Therefore, such a packaging technology can enhance the usage efficiency of the circuit board or package carrier. In addition, embedding a multi-layer ceramic capacitor into the circuit board or the package carrier can reduce the acoustic noise, increase bending resistance, decrease equivalent series inductance (ESL) of the multi-layer ceramic capacitor.

Typically, when a multi-layer ceramic capacitor is embedded into a circuit board, a recess that can accommodate the multi-layer ceramic capacitor is first formed on the circuit board, and then the multi-layer ceramic capacitor is mounted in the recess. Next, an insulating layer is formed to cover the circuit board and the multi-layer ceramic capacitor, and via holes are formed in the insulating layer to expose two terminal electrodes of the multi-layer ceramic capacitor. Subsequently, the via holes are filled with a conductive material to form vias, and wires are formed on the circuit board and the vias, such that the multi-layer ceramic capacitor can be electrically connected to external devices through the vias and the wires.

However, such embedding method includes the steps such as forming an insulating layer, drilling holes in the insulating layer, and filling the conductive material into the via holes, such that the process is complicated. In addition, in the production of the terminal electrodes, two end surfaces of the multi-layer brick are first coated with molten metal to form first metal layers, and then other metal layers that are convenient for welding are then plated. However, the terminal electrode has large surface roughness and poor thickness uniformity by using such method. When the multi-layer ceramic capacitor is embedded in the circuit board, the large surface roughness and the low thickness uniformity of the terminal electrodes will result in reduced connection reliability between the terminal electrodes and the vias that connect the terminal electrodes and the wires, which are connected to other devices of the package structure, such that the packaging yield is decreased.

### SUMMARY

One objective of the present disclosure is to provide an embedded multi-layer ceramic capacitor, which can solve the problems caused when the conventional multi-layer ceramic capacitors are applied in embedded package structures.

According to the aforementioned objectives, the present disclosure provides an embedded multi-layer ceramic capacitor. The embedded multi-layer ceramic capacitor includes a multi-layer brick, a first terminal electrode, and a second terminal electrode. The multi-layer brick includes a ceramic body, plural first internal electrodes, and plural second internal electrodes. The ceramic body has an upper surface and a lower surface, and a first side surface and a second side surface that are opposite to each other, in which the first side surface and the second side surface are located between the upper surface and the lower surface. The first internal electrodes and the second internal electrodes are embedded in the ceramic body alternately and are spaced apart from each other. Each of the first internal electrodes and the second internal electrodes includes a first portion and a second portion. The first portion extends between the first side surface and the second side surface, and is spaced apart from the first side surface, the second side surface, the upper surface, and the lower surface. The second portion extends from a portion of a top surface of the first portion to the upper surface of the ceramic body, and a top surface of the second portion is exposed in the upper surface. The second portions of the first internal electrodes and the second portions of the second internal electrodes are opposite to each other. The first terminal electrode extends to cover the top surfaces of the second portions of the first internal electrodes. The second terminal electrode extends to cover the top surfaces of the second portions of the second internal electrodes.

According to one embodiment of the present disclosure, the first internal electrodes and the second internal electrodes are substantially perpendicular to the upper surface and the lower surface.

According to one embodiment of the present disclosure, each of the first internal electrodes is in an inverted L shape, and each of the second internal electrodes is in an L shape.

According to one embodiment of the present disclosure, each of the first terminal electrode and the second terminal electrode is an electroplated copper structure.

According to one embodiment of the present disclosure, each of the first terminal electrode and the second terminal electrode includes an electroplated copper layer, an electroplated nickel layer, and an electroplated tin layer stacked in sequence.

According to one embodiment of the present disclosure, the first internal electrodes, the second internal electrodes, portions of the ceramic body sandwiched between the first internal electrodes and the second internal electrodes, the first terminal electrode, and the second terminal electrode form a first capacitor unit, and the embedded multi-layer ceramic capacitor further includes at least one second capacitor unit located in the multi-layer brick.

According to one embodiment of the present disclosure, a configuration of the at least one second capacitor unit is the same as a configuration of the first capacitor unit, and each of the at least one second capacitor unit includes plural first internal electrodes and plural second internal electrodes that are the same in number as the first internal electrodes and the second internal electrodes of the first capacitor unit.

According to one embodiment of the present disclosure, a configuration of the at least one second capacitor unit is the same as a configuration of the first capacitor unit, and each of the at least one second capacitor unit includes plural first internal electrodes and plural second internal electrodes that are different in number from the first internal electrodes and the second internal electrodes of the first capacitor unit.

According to one embodiment of the present disclosure, a configuration of the at least one second capacitor unit is the same as a configuration of the first capacitor unit, and a number of the at least one second capacitor unit is plural. Each of the second capacitor units includes plural first internal electrodes and plural second internal electrodes, and numbers of the first internal electrodes and the second internal electrodes of the second capacitor units are different from each other.

According to one embodiment of the present disclosure, a configuration of the at least one second capacitor unit is the same as a configuration of the first capacitor unit, and a number of the at least one second capacitor unit is plural. Each of the second capacitor units includes plural first internal electrodes and plural second internal electrodes. The second capacitor units are divided into plural groups, in which numbers of the first internal electrodes and the second internal electrodes of the second capacitor units in each of the groups are the same.

According to the aforementioned examples, the second portions of the first internal electrodes and the second internal electrodes of the embedded multi-layer ceramic capacitor protrude from the top surfaces of the first portions, and the top surfaces of the second portions are exposed in the upper surface of the ceramic body. Therefore, an electroplating process can be used to grow two terminal electrodes with a desired height and high quality on two opposite areas of the upper surface of the ceramic body based on the exposed portions of the first internal electrodes and the second internal electrodes. In addition, the height of the embedded multi-layer ceramic capacitor can be adjusted according to the thickness of the package carrier, and the terminal electrodes of the embedded multi-layer ceramic capacitor can protrude from the top of the package carrier, such that wires connecting the embedded multi-layer ceramic capacitor to the outside can be directly formed on the upper surface of the ceramic body and the surface of the package carrier. Therefore, the application of the embedded multi-layer ceramic capacitor can greatly reduce the complexity of the packaging process and enhance the yield of the packaging process.

Furthermore, the two terminal electrodes both are located on the upper surface of the ceramic body, such that an oxidation protection treatment of the terminal electrodes can be only performed on the areas on the upper surface of the ceramic body, thereby simplifying the oxidation protection treatment and reducing the oxidation risk of the terminal electrodes.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic three-dimensional diagram of an embedded multi-layer ceramic capacitor in accordance with a first embodiment of the present disclosure.

FIG. 2 is a schematic perspective view of a multi-layer brick of the embedded multi-layer ceramic capacitor in accordance with the first embodiment of the present disclosure.

FIG. 3 is a schematic three-dimensional diagram of an embedded multi-layer ceramic capacitor in accordance with a second embodiment of the present disclosure.

FIG. 4 is a schematic perspective view of a multi-layer brick of the embedded multi-layer ceramic capacitor in accordance with the second embodiment of the present disclosure.

FIG. 5 is a schematic three-dimensional diagram of an embedded multi-layer ceramic capacitor in accordance with a third embodiment of the present disclosure.

FIG. 6 is a schematic perspective view of a multi-layer brick of the embedded multi-layer ceramic capacitor in accordance with the third embodiment of the present disclosure.

FIG. 7 is a schematic three-dimensional diagram of an embedded multi-layer ceramic capacitor in accordance with a fourth embodiment of the present disclosure.

FIG. 8A to FIG. 9B are schematic flow diagrams illustrating packaging an embedded multi-layer ceramic capacitor in a package carrier in accordance with one embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms “connected”, “electrically connected”, or the like between two components referred to in the present disclosure are not limited to the direct connection or electrical connection of the two components, and may also include indirect connection or electrical connection as required.

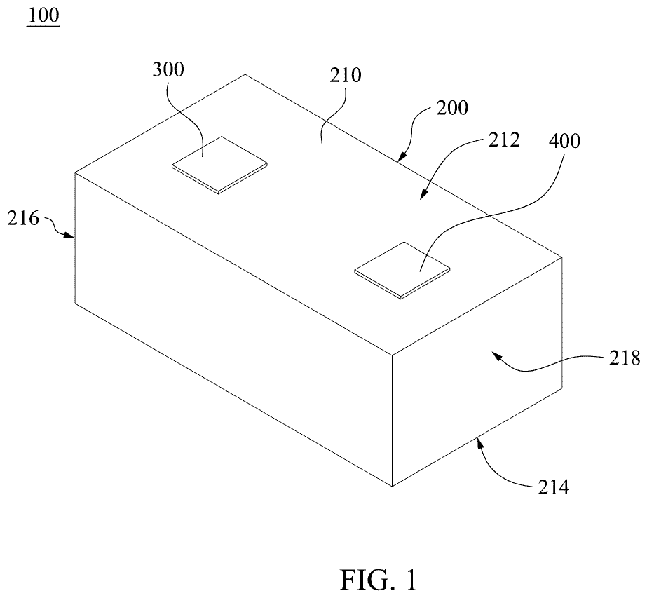

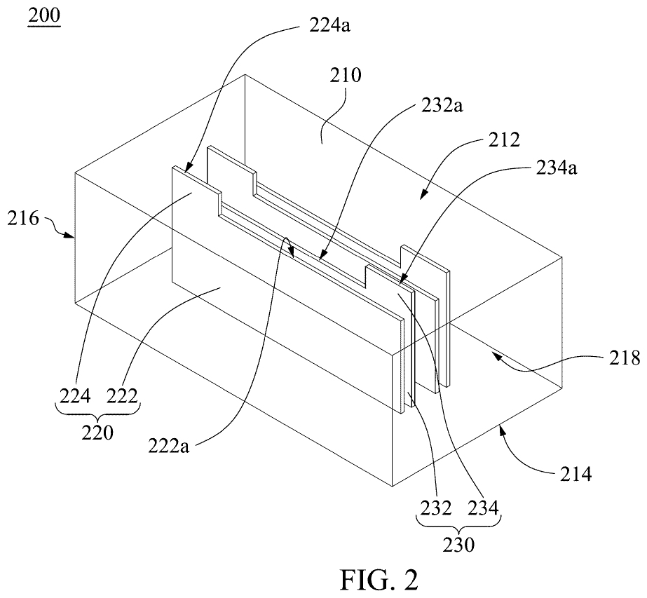

Referring to FIG. 1 and FIG. 2, FIG. 1 and FIG. 2 respectively illustrate a schematic three-dimensional diagram of an embedded multi-layer ceramic capacitor 100 and a schematic perspective view of a multi-layer brick 200 of the embedded multi-layer ceramic capacitor 100 in accordance with a first embodiment of the present disclosure. The embedded multi-layer ceramic capacitor 100 is suitable for an embedded package structure. However, the embedded multi-layer ceramic capacitor 100 may also be applied to other package structures, and the present disclosure is not limited thereto. The embedded multi-layer ceramic capacitor 100 may mainly include the multi-layer brick 200, a first terminal electrode 300, and a second terminal electrode 400.

A shape of the multi-layer brick 200 may be designed according to product requirements. For example, the multi-layer brick 200 may be a cuboid or a cube. The multi-layer brick 200 may mainly include a ceramic body 210, plural first internal electrodes 220, and plural second internal electrodes 230. In the manufacturing of the multi-layer brick 200, plural ceramic green sheets, the first internal electrodes 220, and the second internal electrodes 230 may be alternately stacked to form a stacked structure, and then the stacked structure is sintered. The ceramic body 210 is formed by sintering the ceramic green sheets.

In the example shown in FIG. 1, the ceramic body 210 is a cuboid. The ceramic body 210 may have an upper surface 212 and a lower surface 214, and a first side surface 216 and a second side surface 218 that are opposite to each other. The first side surface 216 and the second side surface 218 both are located between the upper surface 212 and the lower surface 214. In some examples, the upper surface 212 and the lower surface 214 are parallel to each other, and the first side surface 216 and the second side surface 218 are parallel to each other and substantially perpendicular to the upper surface 212 and the lower surface 214.

As shown in FIG. 2, the first internal electrodes 220 and the second internal electrodes 230 are sheet structures. The first internal electrodes 220 and the second internal electrodes 230 are embedded in the ceramic body 210 and are physically separated from each other. The first internal electrodes 220 and the second internal electrodes 230 are alternately arranged.

Each of the first internal electrodes 220 includes a first portion 222 and a second portion 224, which are connected to each other. The first portion 222 extends between the first side surface 216 and the second side surface 218 of the ceramic body 210. The first portion 222 is separated from the first side surface 216, the second side surface 218, the upper surface 212, and the lower surface 214, that is, the first portion 222 is completely located within the ceramic body 210 without being exposed. Specifically, the first portion 222 is vertically disposed above the lower surface 214 and between the lower surface 214 and the upper surface 212. The first portion 222 may be a square or rectangular sheet structure. The first portion 222 has a top surface 222a that faces the upper surface 212 of the ceramic body 210.

The second portion 224 of the first internal electrode 220 is connected to the top surface 222a of the first portion 222, and extends from the top surface 222a to the upper surface 212 of the ceramic body 210. Therefore, the top surface 224a of the second portion 224 is exposed in the upper surface 212. The second portion 224 may be a square or rectangular sheet structure. The second portion 224 is shorter than the first portion 222, such that the second portion 224 is only located on a portion of the top surface 222a of the first portion 222. For example, as shown in FIG. 2, the second portion 224 may be located on one end of the top surface 222a of the first portion 222, such that the first internal electrode 220 is in an inverted L-shape.

Similarly, each of the second internal electrodes 230 includes a first portion 232 and a second portion 234, which are connected to each other. The first portion 232 extends between the first side surface 216 and the second side surface 218 of the ceramic body 210. The first portion 232 is separated from the first side surface 216, the second side surface 218, the upper surface 212, and the lower surface 214. Therefore, the first portion 232 is completely located within the ceramic body 210 without being exposed. Specifically, the first portion 232 is vertically disposed between the lower surface 214 and the upper surface 212. The first portion 232 may be a square or rectangular sheet structure. The first portion 232 has a top surface 232a that faces the upper surface 212.

The second portion 234 of the second internal electrode 230 is connected to the top surface 232a of the first portion 232, and extends from the top surface 232a to the upper surface 212 of the ceramic body 210. Therefore, the top surface 234a of the second portion 234 is exposed in the upper surface 212. The second portion 234 may be a square or rectangular sheet structure. The second portion 234 is shorter than the first portion 232, and is only located on a portion of the top surface 232a of the first portion 232. The second portion 234 of the second internal electrode 230 and the second portion 224 of the first internal electrode 220 are opposite to each other. For example, the second portion 234 may be located on one end of the top surface 232a, such that the second internal electrode 230 is in an L-shape.

In some examples, the first internal electrode 220 and the second internal electrode 230 are mirror-symmetrical structures, that is, the second internal electrode 230 can completely overlap the first internal electrode 220 after being turned over 180 degrees. However, the first internal electrode 220 and the second internal electrode 230 may be non-symmetrical structures, and the present disclosure is not limited thereto. In some examples, the first internal electrode 220 and the second internal electrode 230 are substantially perpendicular to the upper surface 212 and the lower surface 214. For example, the first internal electrodes 220 and the second internal electrodes 230 may be made of copper, silver, or nickel.

The first terminal electrode 300 is located on the upper surface 212 of the ceramic body 210, and extends to cover all of the exposed top surfaces 224a of the second portions 224 of the first internal electrodes 220. The first terminal electrode 300 is only located on the upper surface 212 and does not extend to other surfaces of the ceramic body 210. The first terminal electrode 300 may be a single-layer structure. For example, the first terminal electrode 300 may be a layer of electroplated copper structure. In some examples, the first terminal electrode 300 is a multi-layer stacked structure. For example, the first terminal electrode 300 may include an electroplated copper layer, an electroplated nickel layer, and an electroplated tin layer sequentially stacked on the upper surface 212 to facilitate the application on other packaging methods.

The second terminal electrode 400 is located on the upper surface 212 of the ceramic body 210, and extends to cover all of the exposed top surfaces 234a of the second portions 234 of the second internal electrodes 230. Similarly, the second terminal electrode 400 is only located on the upper surface 212 and does not extend to other surfaces of the ceramic body 210. The second terminal electrode 400 may be a single-layer structure or a multi-layer stacked structure. For example, the second terminal electrode 400 may be a layer of electroplated copper structure, or the second terminal electrode 400 may include an electroplated copper layer, an electroplated nickel layer, and an electroplated tin layer sequentially stacked on the upper surface 212.

The top surfaces 224a of the second portions 224 of the first internal electrodes 220 and the top surfaces 234a of the second portions 234 of the second internal electrodes 230 are exposed in the upper surface 212 of the ceramic body 210, such that the first terminal electrode 300 and the second terminal electrode 400 can be respectively grown on two local areas of the upper surface 212 of the ceramic body 210 by using an electroplating method based on the exposed portions of the first internal electrodes 220 and the second internal electrodes 230. The first terminal electrode 300 and the second terminal electrode 400 are formed by the electroplating method, such that each of the first terminal electrode 300 and the second terminal electrode 400 has low surface roughness and uniform thickness.

The first terminal electrode 300 and the second terminal electrode 400 are both located on the upper surface 212 of the ceramic body 210, such that when the embedded multi-layer ceramic capacitor 100 is packaged in a package carrier, wires connected to the first terminal electrode 300 and the second terminal electrode 400 can be directly formed. Therefore, steps such as forming an insulating layer, drilling holes in the insulating layer, and filling the holes of the insulating layer with conductive materials can be eliminated, thereby reducing the complexity of the embedding process of the embedded multi-layer ceramic capacitor 100 and enhancing packaging yield.

The embedded multi-layer ceramic capacitor of the present disclosure can integrate plural multi-layer ceramic capacitor units into a multi-layer brick according to various application requirements. The multi-layer ceramic capacitor units may have the same capacitance value or different capacitance values; or some of the multi-layer ceramic capacitor units have the same capacitance value, and the other of the multi-layer ceramic capacitor units have different capacitance values.

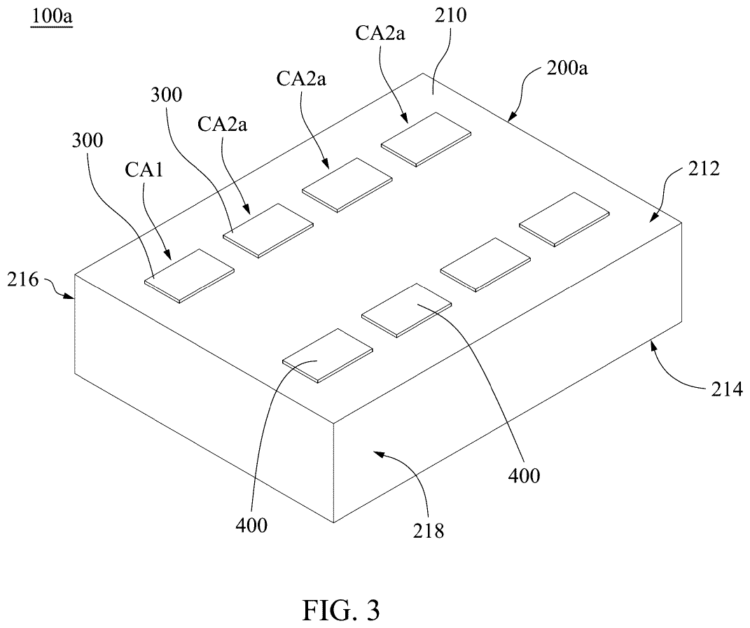

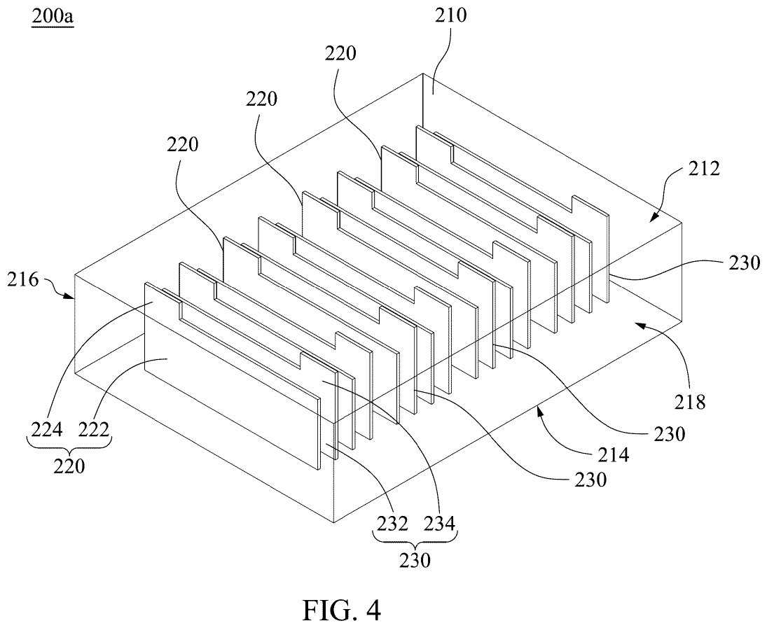

Referring to FIG. 3 and FIG. 4, FIG. 3 and FIG. 4 respectively illustrate a schematic three-dimensional diagram of an embedded multi-layer ceramic capacitor 100a and a schematic perspective view of a multi-layer brick 200a of the embedded multi-layer ceramic capacitor 100a in accordance with a second embodiment of the present disclosure. In the embedded multi-layer ceramic capacitor 100a, the multi-layer brick 200a includes a first capacitor unit CA1 and plural second capacitor units CA2a. There may be only one second capacitor unit CA2a, and the present disclosure is not limited thereto.

The first capacitor unit CA1 is similar to the embedded multi-layer ceramic capacitor 100, and includes the first internal electrodes 220, and the second internal electrodes 230, the portion of the ceramic body 210 sandwiched between the first internal electrodes 220 and the second internal electrodes 230, and the first terminal electrode 300, and the second terminal electrode 400 of the aforementioned embodiment.

A configuration of each of the second capacitor units CA2a is the same as a configuration of the first capacitor unit CA1. That is, each of the second capacitor units CA2a includes plural first internal electrodes 220, plural second internal electrodes 230, a ceramic body 210 sandwiched between the first internal electrodes 220 and the second internal electrodes 230, and two terminal electrodes, and the arrangement of the first internal electrodes 220 and the second internal electrodes 230 is the same as that of the first capacitor unit CA1. In the present embodiment, a number of the first internal electrodes 220 and the second internal electrodes 230 of each of the second capacitor units CA2a is the same as a number of the first internal electrodes 220 and the second internal electrodes 230 of the first capacitor unit CA1. Therefore, each of the second capacitor units CA2a includes the same first terminal electrode 300 and second terminal electrode 400 as the first capacitor unit CA1. Accordingly, a capacitance value of each of the second capacitor units CA2a may be substantially the same as a capacitance value of the first capacitor unit CA1.

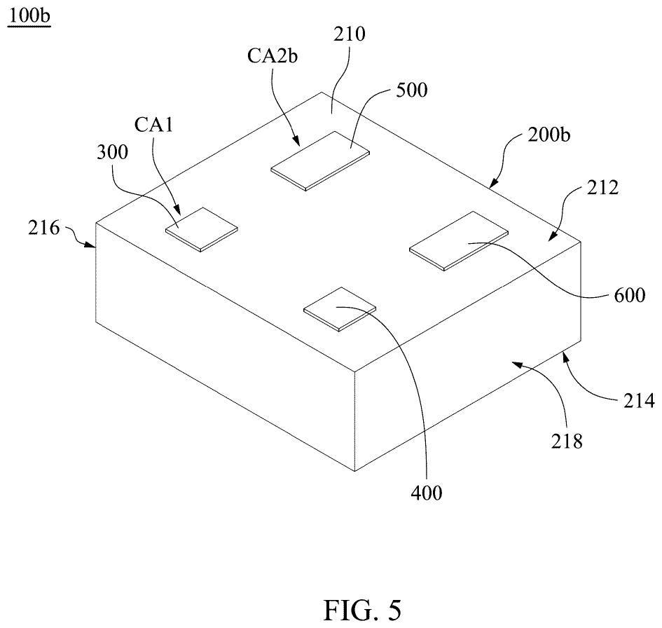

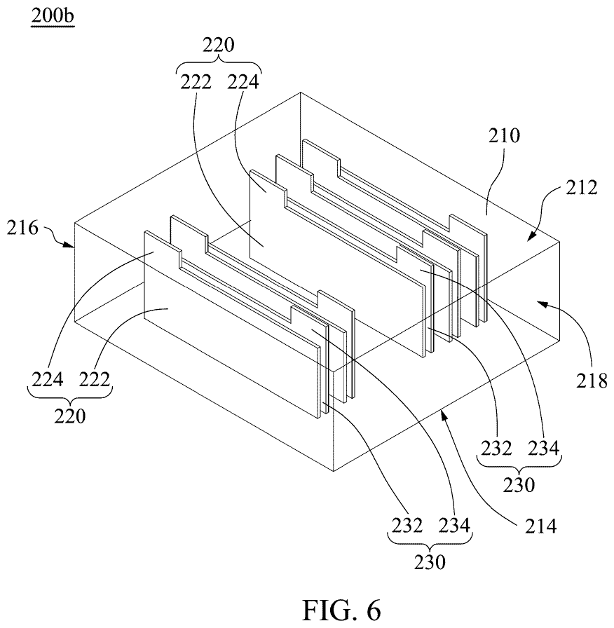

Referring to FIG. 5 and FIG. 6, FIG. 5 and FIG. 6 respectively illustrate a schematic three-dimensional diagram of an embedded multi-layer ceramic capacitor 100b and a schematic perspective view of a multi-layer brick 200b of the embedded multi-layer ceramic capacitor 100b in accordance with a third embodiment of the present disclosure. In the embedded multi-layer ceramic capacitor 100b, the multi-layer brick 200b includes a first capacitor unit CA1 and a second capacitor unit CA2b.

A configuration of the second capacitor unit CA2b is the same as the configuration of the first capacitor unit CA1. That is, the second capacitor unit CA2b includes plural first internal electrodes 220, plural second internal electrodes 230, a ceramic body 210 sandwiched between the first internal electrodes 220 and the second internal electrodes 230, and two terminal electrodes, and the arrangement of the first internal electrodes 220 and the second internal electrodes 230 is the same as that of the first capacitor unit CA1. In the present embodiment, a number of the first internal electrodes 220 and the second internal electrodes 230 of the second capacitor unit CA2b is different from the number of the first internal electrodes 220 and the second internal electrodes 230 of the first capacitor unit CA1. In the embodiment shown in FIG. 6, the second capacitor unit CA2b has more first internal electrodes 220 and more second internal electrodes 230 than the first capacitor unit CA1. The second capacitor unit CA2b has more first internal electrodes 220 and more second internal electrodes 230, such that a first terminal electrode 500 and a second terminal electrode 600 of the second capacitor unit CA2b are respectively greater than the first terminal electrode 300 and the second terminal electrode 400 of the first capacitor unit CA1. A capacitance value of the second capacitor unit CA2b is greater than the capacitance value of the first capacitor unit CA1.

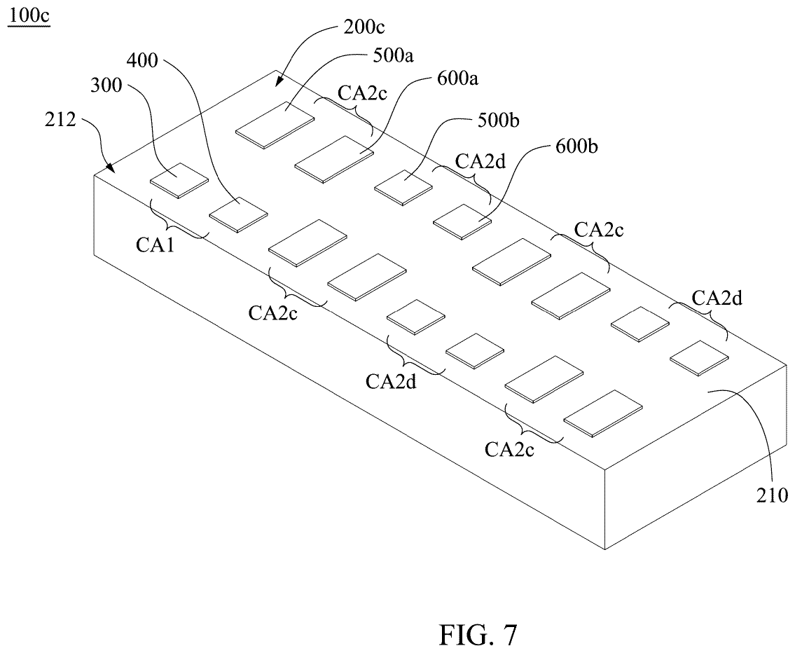

Referring to FIG. 7, FIG. 7 is a schematic three-dimensional diagram of an embedded multi-layer ceramic capacitor 100c in accordance with a fourth embodiment of the present disclosure. In the embedded multi-layer ceramic capacitor 100c, a multi-layer brick 200c includes a first capacitor unit CA1 and plural second capacitor units CA2c and CA2d.

A configuration of each second capacitor unit CA2c and CA2d is the same as the configuration of the first capacitor unit CA1. Referring to FIG. 2 simultaneously, similar to the first capacitor unit CA1, each of the second capacitor units CA2c and CA2d includes plural first internal electrodes 220, plural second internal electrodes 230, a ceramic body 210 sandwiched between the first internal electrodes 220 and the second internal electrodes 230, and two terminal electrodes, and the arrangement of the first internal electrodes 220 and the second internal electrodes 230 is the same as that of the first capacitor unit CA1.

A number of the first internal electrodes 220 and the second internal electrodes 230 of each of the second capacitor units CA2c is different from a number of the first internal electrodes 220 and the second internal electrodes 230 of each of the second capacitor units CA2d. Therefore, sizes of a first terminal electrode 500a and a second terminal electrode 600a of each of the second capacitor units CA2c are different from sizes of a first terminal electrode 500b and a second terminal electrode 600b of each of the second capacitor units CA2d.

In the present embodiment, the second capacitor units CA2c and CA2d are divided into a group composed of four second capacitor units CA2c and a group composed of three second capacitor units CA2d. In the group composed of the second capacitor units CA2c, the four second capacitor units CA2c include the same number of first internal electrodes 220 and the same number of second internal electrodes 230. In the group composed of the second capacitor units CA2d, the three second capacitor units CA2d include the same number of first internal electrodes 220 and the same number of second internal electrodes 230. Therefore, the second capacitor units CA2c have substantially the same capacitance value, and the second capacitor units CA2d have substantially the same capacitance value.

The present disclosure is not limited to the aforementioned embodiments. Similar to the aforementioned embodiments, plural first capacitor units CA1 and plural other capacitor units, such as the second capacitor units CA2b, CA2c, and CA2d, may be integrated together. The second capacitor units CA2b, CA2c, and CA2d include different numbers of first internal electrodes 220 and second internal electrodes 230.

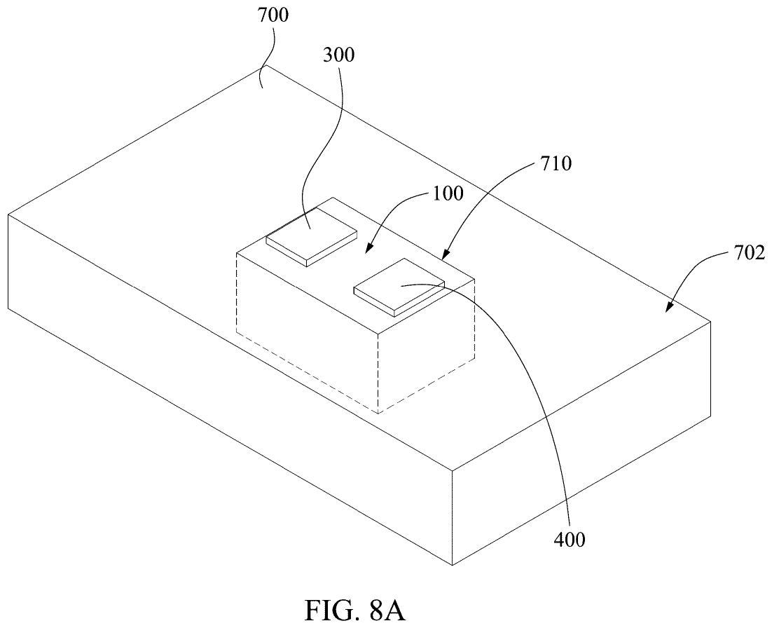

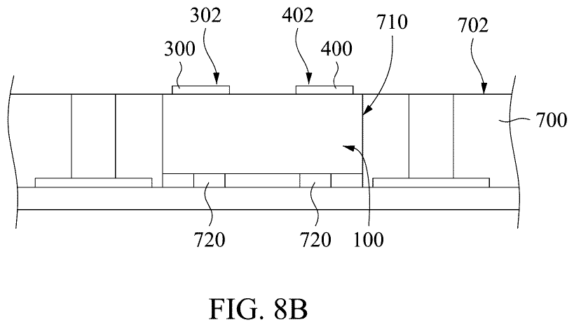

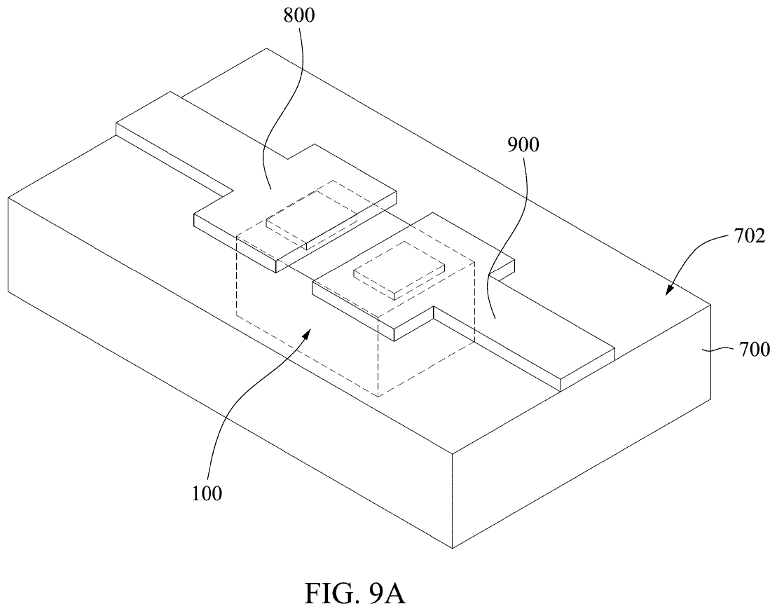

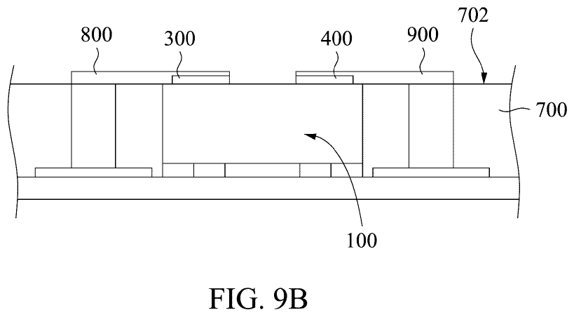

Referring to FIG. 8A to FIG. 9B, FIG. 8A to FIG. 9B are schematic flow diagrams illustrating packaging an embedded multi-layer ceramic capacitor 100 in a package carrier 700 in accordance with one embodiment of the present disclosure, in which FIG. 8A and FIG. 9A are perspective views, and FIG. 8B and FIG. 9B are cross-sectional views. The package carrier 700 may be, for example, a circuit board. The package carrier 700 has a recess 710. A shape of the recess 710 corresponds to a shape of the embedded multi-layer ceramic capacitor 100, and a size of the recess 710 may be slightly greater than the embedded multi-layer ceramic capacitor 100 to facilitate placement of the embedded multi-layer ceramic capacitor 100. As shown in FIG. 8A and FIG. 8B, in the packaging, the embedded multi-layer ceramic capacitor 100 may be first placed into the recess 710, and the embedded multi-layer ceramic capacitor 100 may be fixed in the recess 710 by using an adhesive layer 720.

In the example shown in FIG. 8B, the first terminal electrode 300 and the second terminal electrode 400 of the embedded multi-layer ceramic capacitor 100 are higher than an upper surface 702 of the package carrier 700. In other examples, a height of the embedded multi-layer ceramic capacitor 100 can be adjusted, such that an upper surface 302 of the first terminal electrode 300 and an upper surface 402 of the second terminal electrode 400 are substantially flush with the upper surface 702 of the package carrier 700.

Then, as shown in FIG. 9A and FIG. 9B, wires 800 and 900 may be directly formed by, for example, using a printing method or a deposition method. The wire 800 covers the first terminal electrode 300 of the embedded multi-layer ceramic capacitor 100 and is electrically connected to the first terminal electrode 300. The wire 900 covers the second terminal electrode 400 of the embedded multi-layer ceramic capacitor 100 and is electrically connected to the second terminal electrode 400. The embedded multi-layer ceramic capacitor 100 can be electrically connected to other devices through the wires 800 and 900. For example, two terminal electrodes of another capacitor can be respectively mounted on the wires 800 and 900, such that the embedded multi-layer ceramic capacitor 100 can be electrically connected to the capacitor through the wires 800 and 900. A material of the wires 800 and 900 may be copper.

The first terminal electrode 300 and the second terminal electrode 400 of the embedded multi-layer ceramic capacitor 100 both are located on an upper side of the embedded multi-layer ceramic capacitor 100, and the first terminal electrode 300 and the second terminal electrode 400 of the embedded multi-layer ceramic capacitor 100 can be formed to protrude from the upper surface 702 of the package carrier 700 by adjusting the height of the embedded multi-layer ceramic capacitor 100. Thus, the step of forming the insulating layer, the step of drilling the insulating layer, and the step of filling the holes with the conductive material can be omitted, thereby simplifying the packaging process and enhancing the yield of the packaging process.

According to the aforementioned embodiments, the second portions of the first internal electrodes and the second internal electrodes of the embedded multi-layer ceramic capacitor of the present disclosure are protruding from the top surfaces of the first portions, and the top surfaces of the second portions are exposed in the upper surface of the ceramic body. Therefore, an electroplating process can be used to grow two terminal electrodes with a desired height and high quality on two opposite areas of the upper surface of the ceramic body based on the exposed portions of the first internal electrodes and the second internal electrodes. In addition, the height of the embedded multi-layer ceramic capacitor can be adjusted according to the thickness of the package carrier, and the terminal electrodes of the embedded multi-layer ceramic capacitor can protrude from the top of the package carrier, such that wires connecting the embedded multi-layer ceramic capacitor to the outside can be directly formed on the upper surface of the ceramic body and the surface of the package carrier. Therefore, the application of the embedded multi-layer ceramic capacitor can greatly reduce the complexity of the packaging process and enhance the yield of the packaging process.

Furthermore, the two terminal electrodes both are located on the upper surface of the ceramic body, such that an oxidation protection treatment of the terminal electrodes can be concentrated on the areas on the upper surface of the ceramic body, thereby simplifying the oxidation protection treatment and reducing the oxidation risk of the terminal electrodes.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. An embedded multi-layer ceramic capacitor, comprising:
a multi-layer brick comprising:
a ceramic body having an upper surface and a lower surface, and a first side surface and a second side surface that are opposite to each other, wherein the first side surface and the second side surface are located between the upper surface and the lower surface; and
a plurality of first internal electrodes and a plurality of second internal electrodes embedded in the ceramic body alternately and spaced apart from each other, wherein each of the first internal electrodes and the second internal electrodes comprises:
a first portion extending between the first side surface and the second side surface, and spaced apart from the first side surface, the second side surface, the upper surface, and the lower surface; and
a second portion extending from a portion of a top surface of the first portion to the upper surface of the ceramic body, and a top surface of the second portion being exposed in the upper surface, wherein the second portions of the first internal electrodes and the second portions of the second internal electrodes are opposite to each other;
a first terminal electrode extending to cover the top surfaces of the second portions of the first internal electrodes; and
a second terminal electrode extending to cover the top surfaces of the second portions of the second internal electrodes.

2. The embedded multi-layer ceramic capacitor of claim 1, wherein the first internal electrodes and the second internal electrodes are substantially perpendicular to the upper surface and the lower surface.

3. The embedded multi-layer ceramic capacitor of claim 1, wherein each of the first internal electrodes is in an inverted L shape, and each of the second internal electrodes is in an L shape.

4. The embedded multi-layer ceramic capacitor of claim 1, wherein each of the first terminal electrode and the second terminal electrode is an electroplated copper structure.

5. The embedded multi-layer ceramic capacitor of claim 1, wherein each of the first terminal electrode and the second terminal electrode comprises an electroplated copper layer, an electroplated nickel layer, and an electroplated tin layer stacked in sequence.

6. The embedded multi-layer ceramic capacitor of claim 1, wherein the first internal electrodes, the second internal electrodes, portions of the ceramic body sandwiched between the first internal electrodes and the second internal electrodes, the first terminal electrode, and the second terminal electrode form a first capacitor unit, and the embedded multi-layer ceramic capacitor further comprises at least one second capacitor unit located in the multi-layer brick.

7. The embedded multi-layer ceramic capacitor of claim 6, wherein a configuration of the at least one second capacitor unit is the same as a configuration of the first capacitor unit, and each of the at least one second capacitor unit comprises a plurality of first internal electrodes and a plurality of second internal electrodes that are the same in number as the first internal electrodes and the second internal electrodes of the first capacitor unit.

8. The embedded multi-layer ceramic capacitor of claim 6, wherein a configuration of the at least one second capacitor unit is the same as a configuration of the first capacitor unit, and each of the at least one second capacitor unit comprises a plurality of first internal electrodes and a plurality of second internal electrodes that are different in number from the first internal electrodes and the second internal electrodes of the first capacitor unit.

9. The embedded multi-layer ceramic capacitor of claim 6, wherein a configuration of the at least one second capacitor unit is the same as a configuration of the first capacitor unit, a number of the at least one second capacitor unit is plural, each of the second capacitor units comprises a plurality of first internal electrodes and a plurality of second internal electrodes, and numbers of the first internal electrodes and the second internal electrodes of the second capacitor units are different from each other.

10. The embedded multi-layer ceramic capacitor of claim 6, wherein a configuration of the at least one second capacitor unit is the same as a configuration of the first capacitor unit, a number of the at least one second capacitor unit is plural, each of the second capacitor units comprises a plurality of first internal electrodes and a plurality of second internal electrodes, and the second capacitor units are divided into a plurality of groups, wherein numbers of the first internal electrodes and the second internal electrodes of the second capacitor units in each of the groups are the same.
